(19) United States
(12) Patent Application Publication
(10) Pub. No.: US 2022/0046901 A1
(43) Pub. Date: Feb. 17, 2022

(54) Interceptor

(71) Applicants: Gary Arandus, SR., Denton, TX (US); Glendyne Arandus, Denton, TX (US)

(72) Inventors: Gary Arandus, SR., Denton, TX (US); Glendyne Arandus, Denton, TX (US)

(21) Appl. No.: 16/993,936

(22) Filed: Aug. 14, 2020

(51) Int. Cl. A01K 39/01

(52) U.S. Cl. CPC A01K 39/01

(57) ABSTRACT

A portable debris catcher apparatus mounted from a bird feeder to collect and recycle bird seed debris; a first inwardly sloped bowl connected to a vertical removable container; the inwardly sloped bowl to allow for debris to be caught and slide into the removable container from a hole in the middle of the bottom of the bowl; the removable container attached directly below the bowl for the debris to be collected; the removable container containing holes or slits or made of a material to allow liquid to pass through. The removable container allows for water to pass through the underside of the container and collects debris in the cavity of the removable container.

### FIELD OF THE INVENTION

The present invention relates to bird feeders and more particularly to a bird feeder debris catcher to ensure cleanliness and allow for recycling disposed bird feed.

### BACKGROUND

Bird feeders have been used by avid bird watchers and individuals wanting to attract birds into their yard or selected area. Generally, innovations in bird feeders include ways to prevent wasted bird seed, such as preventing squirrels or other animals from stealing bird seed. Other innovations involve improving cleanliness of the surrounding area of the bird feeder. When birds feast on the bird seed at the bird feeder the birds will dispose of the seed husks and in the process of accessing the feeder and quite often disposing the seeds themselves.

Flat bird feeder trays have been developed to hang below the bird feeders and catch the debris for disposal. These flat trays catch the debris but can be unclean themselves since they do not feature any draining capabilities.

There is a need in the industry for a bird seed catcher that allows for seeds and hulls to be easily stored and removed with draining capabilities to preserve the debris so that individuals can recycle the bird seeds and hulls into the bird feeder.

### SUMMARY OF THE INVENTION

The present invention comprises a debris catcher featuring a bowl or funnel shaped upper piece with a removable lower end that features openings for water to drain. The upper piece includes a means to secure the debris interceptor to a bird feeder, using holes in the upper piece to attach the interceptor to the feeder with string or chain.

An embodiment can include a means for the upper piece to attach to the lower piece with threaded connection or slide rail connection. The lower piece features a means to store bird seeds and hulls and can include a means for allowing liquids to pass through for draining.

An embodiment can include a cylindrical plastic or other material lower piece with a threaded top to secure itself to the upper piece.

Another embodiment can use a threaded collar in the neck of the cylindrical lower piece to attach to the upper piece. Another embodiment can include a plastic or other material lower piece with a slide rail structure to dock itself to a receiving end on the bottom of the upper piece.

Another embodiment can use a reusable or disposable bag to secure itself to the bottom of the upper piece by a knot or fastener. Another embodiment can use a simple rod threaded through holes in the lower section of the upper piece and the top section of the lower piece to secure the pieces together.

### BRIEF DESCRIPTION OF THE DRAWINGS

FIG. 1 is a front angled perspective view of the debris interceptor according to various embodiments of the present invention.

FIG. 2 is a top view of the debris interceptor according to various embodiments of the present invention.

FIG. 3 is a bottom view of the debris interceptor according to various embodiments of the present invention.

FIG. 4 is a front perspective view of the upper piece 15 of the debris interceptor according to various embodiments of the present invention.

FIG. 5 is a top view of the upper piece 15 of the debris interceptor according to various embodiments of the present invention.

FIG. 6 is a sectional front view of the upper piece 15 of the debris interceptor according to various embodiments of the present invention.

FIG. 7 is a front perspective view of the lower piece 20 of the debris interceptor according to various embodiments of the present invention.

FIG. 8 is a top view of the lower piece 20 of the debris interceptor according to various embodiments of the present invention.

FIG. 9 is a bottom view of the lower piece 20 of the debris interceptor according to various embodiments of the present invention.

FIG. 10 shows a front angled perspective view of the upper piece of the slide rail design 30 of the debris interceptor according to various embodiments of the present invention.

FIG. 11 shows a front sectional view of the upper piece of the slide rail design 30 of the debris interceptor according to various embodiments of the present invention.

FIG. 12 shows a front angled perspective view of the lower piece of the slide rail design 35 of the debris interceptor according to various embodiments of the present invention.

FIG. 13 shows a front sectional view of the lower piece of the slide rail design 35 of the debris interceptor according to various embodiments of the present invention.

FIG. 14 shows a front perspective view of the reusable bag design 40 of the debris interceptor according to various embodiments of the present invention.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and “comprising”, when used herein, specify the non-limiting presence of stated features, steps, operations, elements, or components, not precluding other like limitations.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A novel debris interceptor for a bird feeder is disclosed herein. In the following description, for purposes of explanation, numerous specific details are set forth in order to provide a thorough understanding of the present invention. It will be evident to one skilled in the art that the present invention may be practiced without these details.

The present disclosure is to be considered as an exemplification of the invention, and is not intended to limit the invention to the specific embodiments illustrated by the figures or description below.

The present invention catches bird seeds and husks that may fall from the bird feeder which would otherwise fall and spread around the ground below the feeder and make the area unappealing and attract unwanted pests. This device allows for concentrated storing of the seed debris and allows draining of liquids from the cavity containing the debris. The present invention allows for an inwardly angled crevice that will allow debris to slide into a smaller removable cavity to be stored. Furthermore, the debris interceptor includes a removable lower section containing the cavity to where the debris is stored allowing for easy disposal of the debris or recycling of the bird seeds and husks. The present invention provides a cavity which may facilitate the flow of water through the cavity by openings on the bottom which may be holes or slits.

The present invention will now be described by referencing the appended figures representing preferred embodiments.

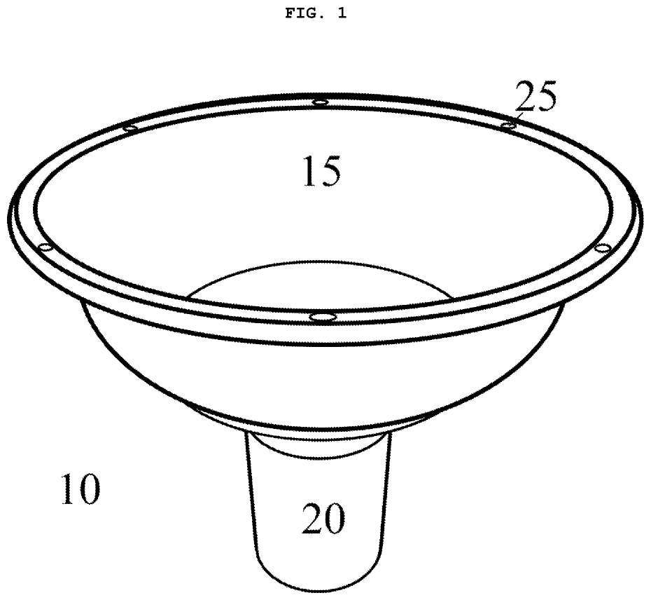

FIG. 1 is a front angled perspective view of the debris interceptor 10 according to various embodiments of the present invention. The debris interceptor 10 consists of an upper piece 15 and a lower piece 20. The upper piece 15 features a lip around the upper edge with attachment holes 25 to allow the debris interceptor 10 to hang from a bird feeder. The upper piece 15 has a wider upper opening and becomes narrower moving downward, such as a bowl or funnel shape. This narrowing diameter allows for fallen seeds and husks to move into the hole found at the bottom of the upper piece 15 to slide the debris into the cavity of the lower piece 20.

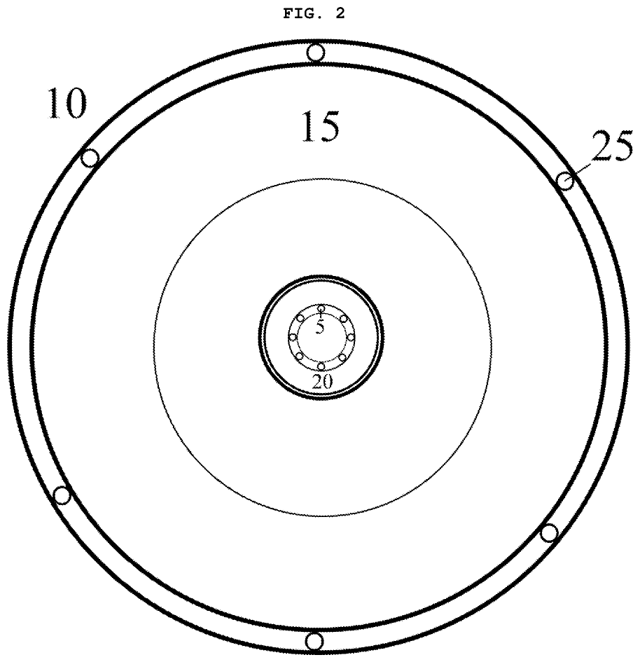

FIG. 2 is at top view of the debris interceptor 10 according to various embodiments of the invention. The upper piece 15 is circular with a lip on the upper edges featuring attachment holes 25 for the debris interceptor 10 to be attached below a bird feeder. The upper piece 15 is inwardly sloping to a hole that allows passage of falling debris to be collected into the cavity of the lower piece 20. The lower piece 20 is attached below the upper piece 15 and features drain holes 5 on the bottom to allow liquids to pass through the collected.

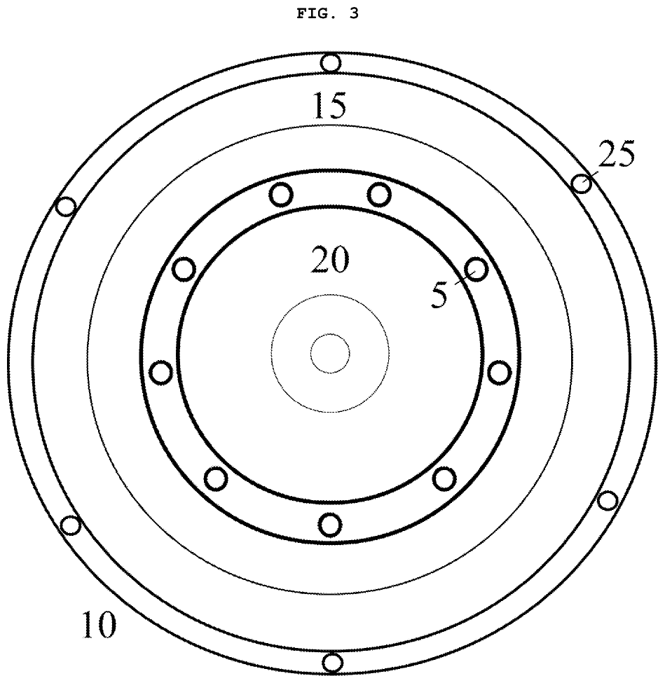

FIG. 3 is a bottom view of the debris interceptor 10 according to various embodiments of the present invention. The upper piece 15 features a lipped edge with attachment holes 25 to allow for the debris interceptor 10 to be hung below a bird feeder. The upper piece 15 is inwardly sloping to allow debris to slide into the cavity of the lower piece 20. The lower piece 20 is hollow to allow debris to be collected and contains drain holes 5 to allow liquid to pass through the debris interceptor.

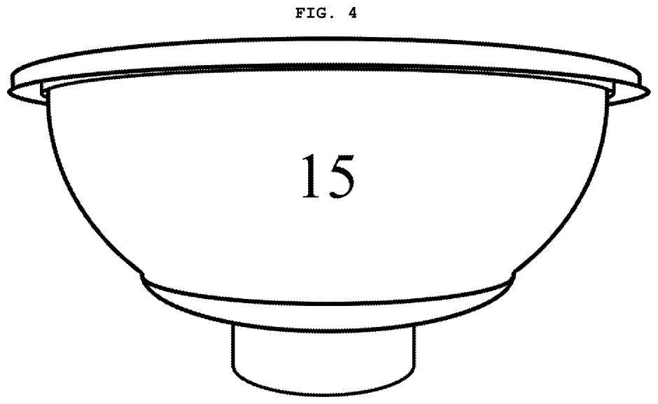

FIG. 4 is a front perspective view of the upper piece 15 of the debris interceptor 10 according to various embodiments of the present invention. The upper piece 15 has a lipped upper edge and features an inwardly sloped cavity to a hole with female thread adapter in the bottom. The bottom of the upper piece 15 includes a thicker reinforced section fusing a female thread connection to the bottom of the upper piece 15. The female thread connection allows the upper piece 15 to connect to the male thread connection on the lower piece 20.

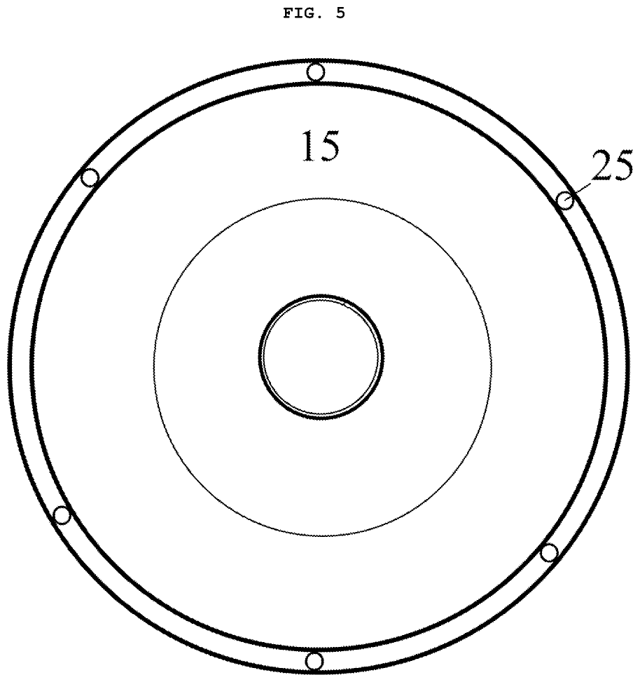

FIG. 5 is a top view of the upper piece 15 of the debris interceptor 10 according to various embodiments of the present invention. The upper piece 15 is circular with an inward sloping cavity to a hole at the bottom including a female thread adapter. The upper piece 15 has a lipped edge with attachment holes 25 to connect the upper piece 15 to a bird feeder.

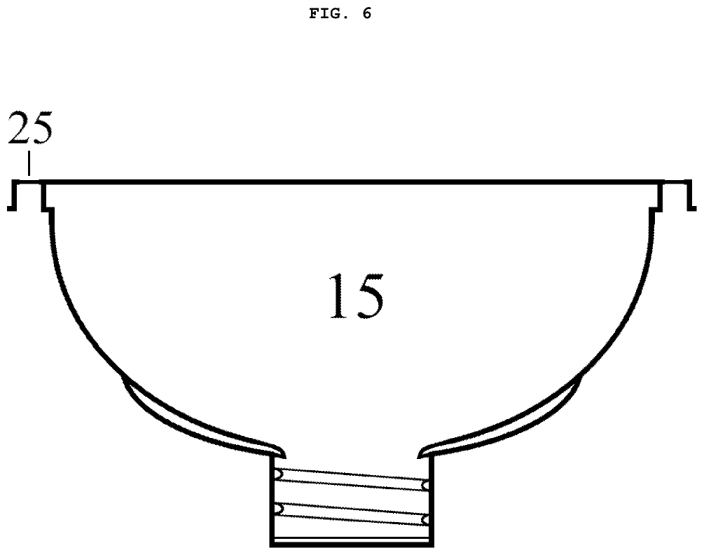

FIG. 6 is a sectional front view of the upper piece 15 of the debris interceptor according to various embodiments of the present invention. The upper piece 15 is bowl shaped with protruding edges on the top featuring attachment holes 25 to connect the upper piece 15 to a bird feeder. The upper piece 15 has a hole on the bottom with a reinforced thicker section leading to a female thread connection surrounding the hole. There is a lip above the female threads to allow bird feeder debris to easily slide down into the hole.

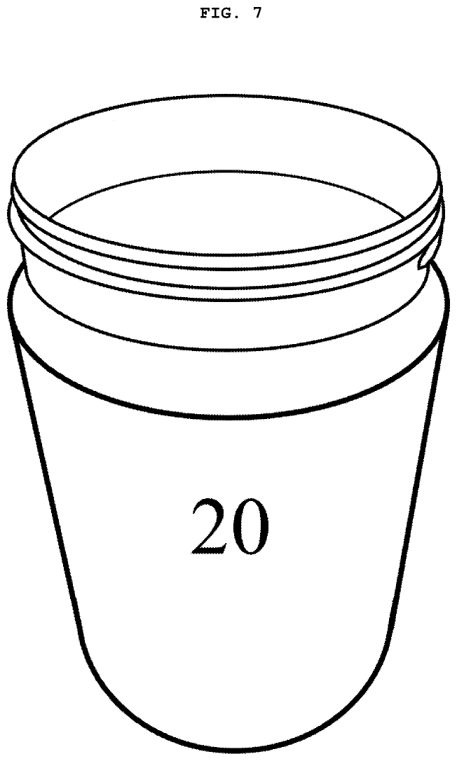

FIG. 7 is a front perspective view of the lower piece 20 of the debris interceptor 10 according to various embodiments of the present invention. The lower piece 20 features an opening at the top with male threads to connect to the female threads of the upper piece 15. The cavity of the lower piece 20 allows for bird seed debris to collect to be recycled into the bird feeder by the user. There are drain holes 5 at the bottom to allow liquids to pass through the cavity.

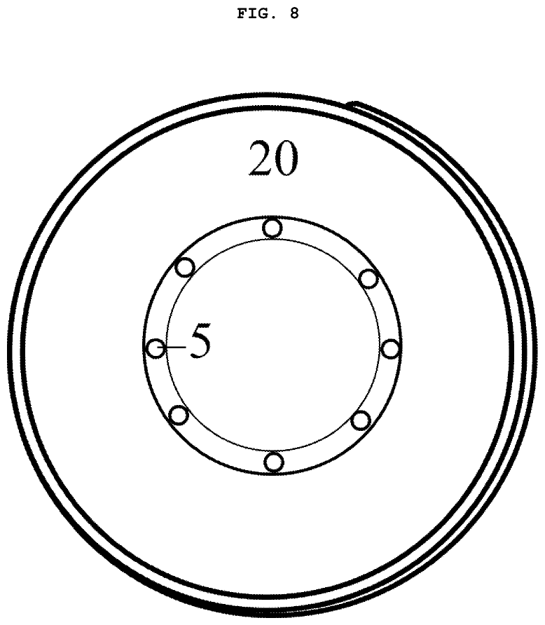

FIG. 8 is a top view of the lower piece 20 of the debris interceptor 10 according to various embodiments of the present invention. The opening of the top of the lower piece 20 features male threads to attach to the female threads of the upper piece 15. The cavity of the lower piece 20 stores bird feed debris and features drain holes 5 at the bottom to allow passage of liquids.

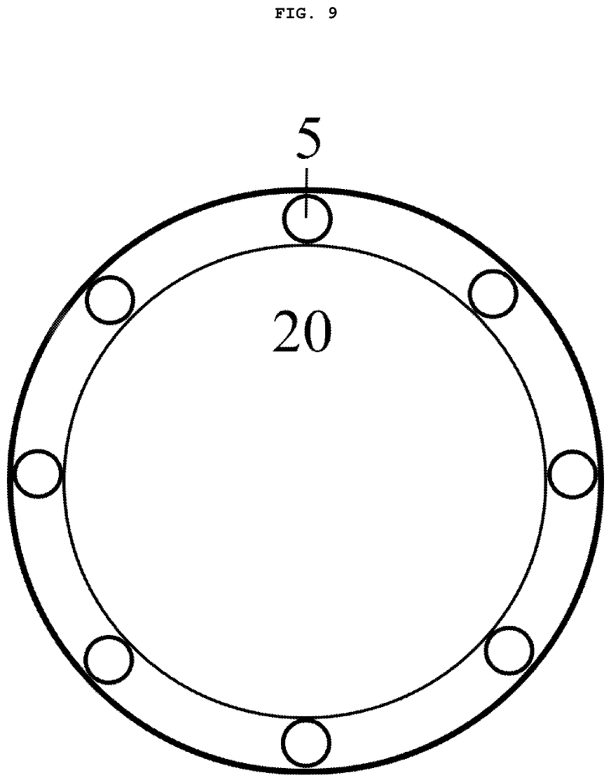

FIG. 9 is a bottom view of the lower piece 20 of the debris interceptor 10 according to various embodiments of the present invention. The lower piece 20 contains a cavity to store fallen bird seed debris for later recycling. The bottom of the lower piece 20 features drain holes 5 for liquid to pass through.

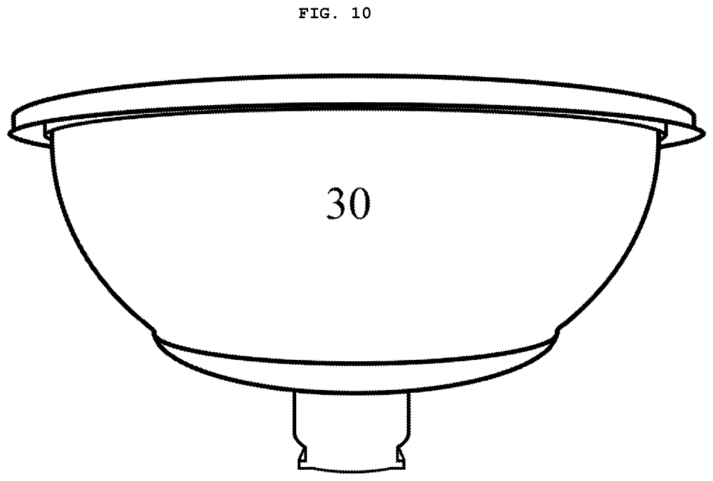

FIG. 10 shows a front perspective view of the upper piece of the slide rail design 30 of the debris interceptor 10 according to various embodiments of the present invention. The upper piece of the slide rail design 30 has a lipped edge with attachment holes 25 to attach to a bird feeder. The upper piece of the slide rail design 30 has an inwardly sloped cavity with a hole on the bottom leading to slide rail attachment to connect to the slide rail attachment of the lower piece of the slide rail design 35.

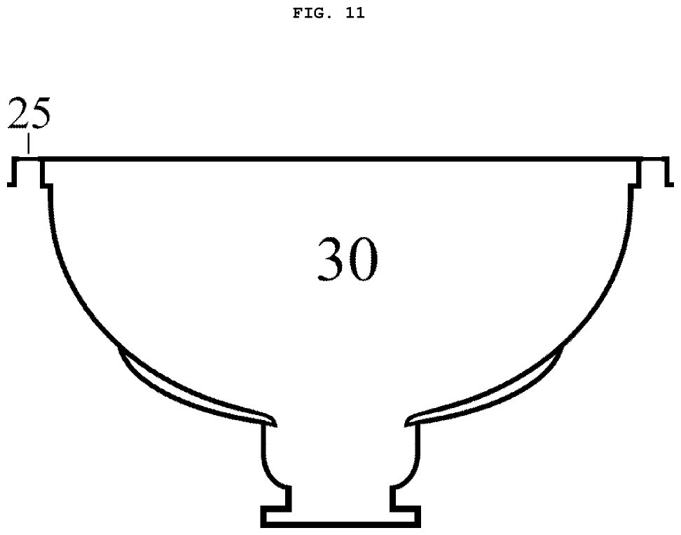

FIG. 11 shows a front sectional view of the upper piece of the slide rail design 30 of the debris interceptor according to various embodiments of the present invention. The upper piece of the slide rail design 30 is bowl shaped with protruding edges on the top featuring attachment holes 25 to connect the upper piece 15 to a bird feeder. The upper piece 15 has a hole on the bottom with a reinforced thicker section leading to a slide rail connection. There is a lip above the slide rail connection to allow bird feeder debris to easily slide down into the hole.

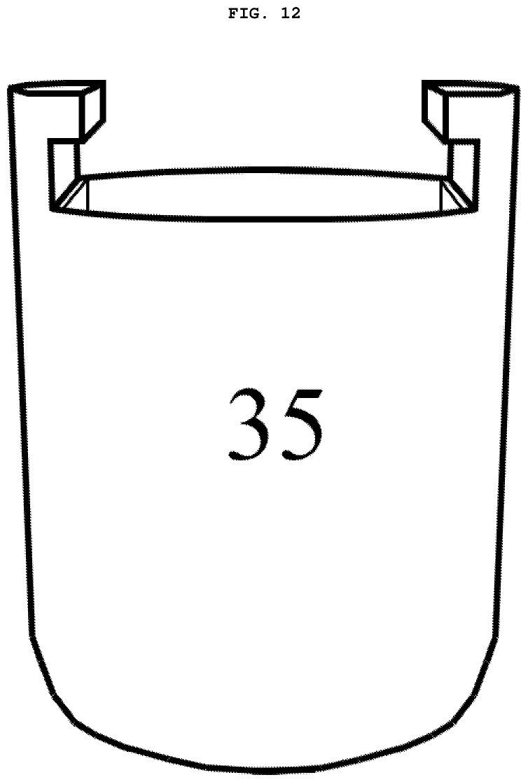

FIG. 12 shows a front angled perspective view of the lower slide rail interceptor design 35 of the debris interceptor according to various embodiments of the present invention. The receptacle of slide rail interceptor design 35 features a cavity to store fallen bird seed debris with drain holes 5 at the bottom to allow passage of liquids. The receptacle of the slide rail design 35 features a slide rail attachment at the top to attach the receptacle of the slide rail design 35 to the bottom of the upper piece of the slide rail design 30.

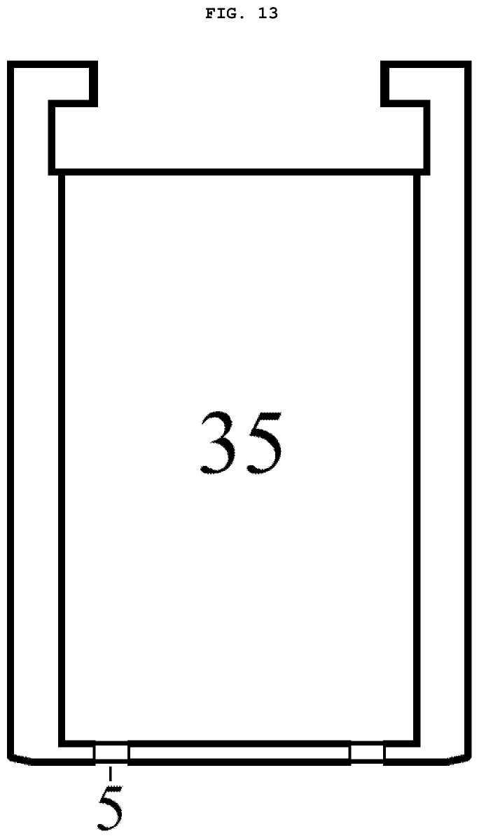

FIG. 13 shows a front sectional view of the lower piece of the slide rail design 35 of the debris interceptor according to various embodiments of the present invention. The receptacle of slide rail interceptor design 35 features a cavity to store fallen bird seed debris with drain holes 5 at the bottom to allow passage of liquids. The receptacle of the slide rail design 35 features a slide rail attachment at the top to attach the receptacle of the slide rail design 35 to the bottom of the upper piece of the slide rail design 30.

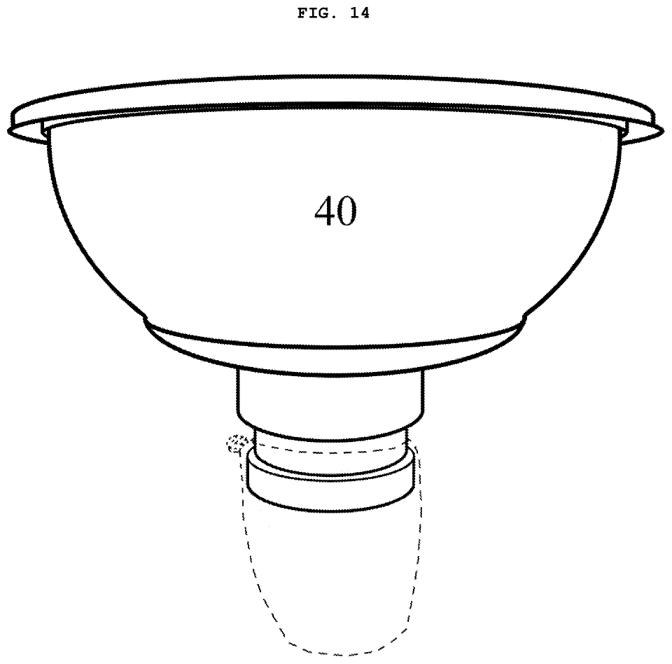

FIG. 14 shows a front perspective view of the reusable bag design 40 of the debris interceptor 10 according to various embodiments of the present invention. The reusable bag design 40 features a lipped edge with attachment holes 25 to attach the reusable bag design 40 to a bird feeder. The reusable bag design 40 features an inward sloping cavity to catch bird seed debris and slide the debris into a hole at the bottom of the reusable bag design 40. There is a neck attachment sealed and formed around below the hole to allow a reusable bag to be tied to the reusable bag design 40 and allow debris to fall into the reusable bag.

A legend of the components discussed and shown in the drawings is as follows:
Drain holes 5
Debris Interceptor 10
Upper piece 15
Lower Piece 20
Attachment holes 25
Upper piece slide rail interceptor design 30
Receptacle of the slide rail interceptor design 35
Reusable bag interceptor piece 40

1. A portable debris catcher mounted from a bird feeder to collect and recycle bird seed debris, comprising:
a) An upper piece wider than the bird feeder, comprising an inwardly sloping bowl shape with one or more holes at the bottom, with a means to attach to a bird feeder, and
b) a lower piece and connected to the upper piece comprising a receptacle with an open top, the lower piece fixed in place under said one or more holes

2. A portable debris catcher apparatus mounted from a bird feeder as in claim 1, further comprising the additional limitation that the lower piece screws into the upper piece by a threaded connection.

3. A portable debris catcher apparatus mounted from a bird feeder as in claim 1, further comprising the additional limitation that the lower piece contains a removable tray slideably mounted in the lower piece.

4. A portable debris catcher apparatus mounted from a bird feeder as in claim 1, further comprising the limitation that the lower piece is a disposable bag.

5. A portable debris catcher apparatus mounted from a bird feeder as in claim 1, further comprising the limitation that the lower piece is a reusable bag.

6. A portable debris catcher as in claim 1 in which the top of the upper piece comprises a lip.

7. A portable debris catcher as in claim 1 in which the receptacle further comprises a means of draining rain from the receptacle without allowing debris to escape the receptacle.

8. A portable debris catcher as in claim 1 in which the receptacle further comprises drainage holes in the bottom of the receptacle which are too small to allow debris to escape the receptacle.

9. A portable debris catcher as in claim 1 in which the means used to attach the upper piece is one or more chains.
